(19) United States
(12) Patent Application Publication
(10) Pub. No.: US 2013/0047774 A1
(43) Pub. Date: Feb. 28, 2013

(54) BICYCLE BRAKE AND SHIFT LEVER ASSEMBLY

(71) Applicant: Adam John CLEMENT, Portland, OR (US)

(72) Inventor: Adam John CLEMENT, Portland, OR (US)

(73) Assignee: RETRO SHIFT LLC, Portland, OR (US)

(21) Appl. No.: 13/481,578

(22) Filed: May 25, 2012

Related U.S. Application Data
(60) Provisional application No. 61/527,980, filed on Aug. 26, 2011.

(51) Int. Cl. G05G 1/04

(52) U.S. Cl. 74/502.2; 74/523

(57) ABSTRACT

A shift and brake lever assembly including a brake lever having a first surface facing a handlebar and a second surface facing away from a handlebar. A shift lever may be mounted to the second surface of the brake lever using mounting components. Complementary apertures of the various mounting components may lie on a common longitudinal axis.

### CROSS-REFERENCE TO RELATED APPLICATION

This application claims priority to U.S. Provisional Patent Application Ser. No. 61/527,980, filed Aug. 26, 2011, which is hereby incorporated by reference into the present disclosure.

### INTRODUCTION

Bicycles with multiple gears typically allow a rider to change gears using front and rear derailleurs, which are moved laterally to shift a bicycle chain from one front chainring to another and from one rear cog to another, respectively. Each derailleur is generally moved by applying tension to an associated derailleur cable through some action of the rider, such as movement of a shift lever.

Early bicycle shifting systems, sometimes called “friction systems,” used shift levers that relied on precise rider movements of the levers to achieve desired derailleur motions. Later, indexed shift levers were developed, which provide mechanical feedback to the rider and thereby allow a rider to move a shift lever a desired discrete amount, corresponding to a gear change. Early shift levers were typically spatially separated from the bicycle brake levers. Later, integrated shift levers were developed, which combine a shift lever and a brake lever into a single assembly.

### SUMMARY

The present teachings disclose a control device for mounting on a bicycle handlebar. The disclosed control device includes a shift lever and a brake lever configured to be attached to the front surface of the brake lever, i.e. the side of the brake lever farthest from the handlebar. The control device can include a shift lever mount that is integrally formed or otherwise manufactured in conjunction with the brake lever, or the control device can include a bracket or mount that attaches to a preexisting brake lever. Some embodiments of the disclosed control device may use specially made shift levers and/or brake levers, whereas other embodiments may allow the use of industry standard levers, including preexisting down tube or bar end style shift levers.

### BRIEF DESCRIPTION OF THE DRAWINGS

FIG. 1 is a side elevational view of an exemplary right-side control device, according to aspects of the present teachings.

FIG. 2 is a front elevational view of the control device of FIG. 1.

FIG. 3 is an exploded side elevational view of another exemplary control device according to aspects of the present teachings.

FIG. 4 is an exploded isometric view of the control device of FIG. 3.

FIG. 5 is a perspective view showing another exemplary right-side control device mounted to a bicycle handlebar, according to aspects of the present teachings.

FIG. 6 is a perspective view showing exemplary right-side and left-side control devices mounted to a bicycle handlebar, according to aspects of the present teachings.

FIGS. 7-11 are front views showing an exemplary right-side control device being moved from one position to another position, according to aspects of the present teachings.

FIG. 12 is a top elevational view showing an exemplary mounting bracket that may be used to attach a shift lever to a brake lever, according to aspects of the present teachings.

FIG. 13 is a rear elevational view of the mounting bracket shown in FIG. 12.

FIG. 14 is a front elevational view of the mounting bracket shown in FIG. 12.

FIG. 15 is a side elevational view of the mounting bracket shown in FIG. 12.

FIG. 16 is a side elevational view of an exemplary alternate brake lever that can be used in conjunction with a shift lever such as the one shown in FIGS. 1-3, according to aspects of the present teachings.

FIG. 17 is a side elevational view of yet another exemplary control device, according to aspects of the present teachings.

FIGS. 18 and 19 are isometric views of yet another exemplary mounting assembly that may be used to attach a shift lever to a brake lever, showing a mounting bracket attached to a brake lever and with a shift lever axle installed in a recess of the mounting bracket, according to aspects of the present teachings.

### DESCRIPTION

In contrast to early non-integrated shift levers, which were often placed along the down tube of a bicycle, many integrated shift levers do not require a rider to remove a hand from the handlebar in order to shift gears. An integrated system of this type is disclosed, for example, in U.S. Pat. No. 5,400,675 assigned to Shimano, Inc., which is hereby incorporated by reference into the present disclosure for all purposes. However, as described below, the Shimano integrated shifting system has certain limitations.

For instance, in the Shimano integrated shifting system for bicycles with drop style handlebars, the shift lever is generally disposed between the brake lever and the handlebar, whereas some riders may prefer a shift lever disposed on the opposite side of the brake lever, farther from the handlebar. Furthermore, the Shimano system typically must be purchased as a complete assembly that cannot be dismantled easily, and is therefore relatively expensive both to purchase and to service. For these reasons among others, some riders might find it desirable to use an integrated shifting system that places the shift levers farther from the handlebar than the brake levers, that can be constructed from preexisting, non-integrated components, and that is relatively inexpensive to purchase and to service.

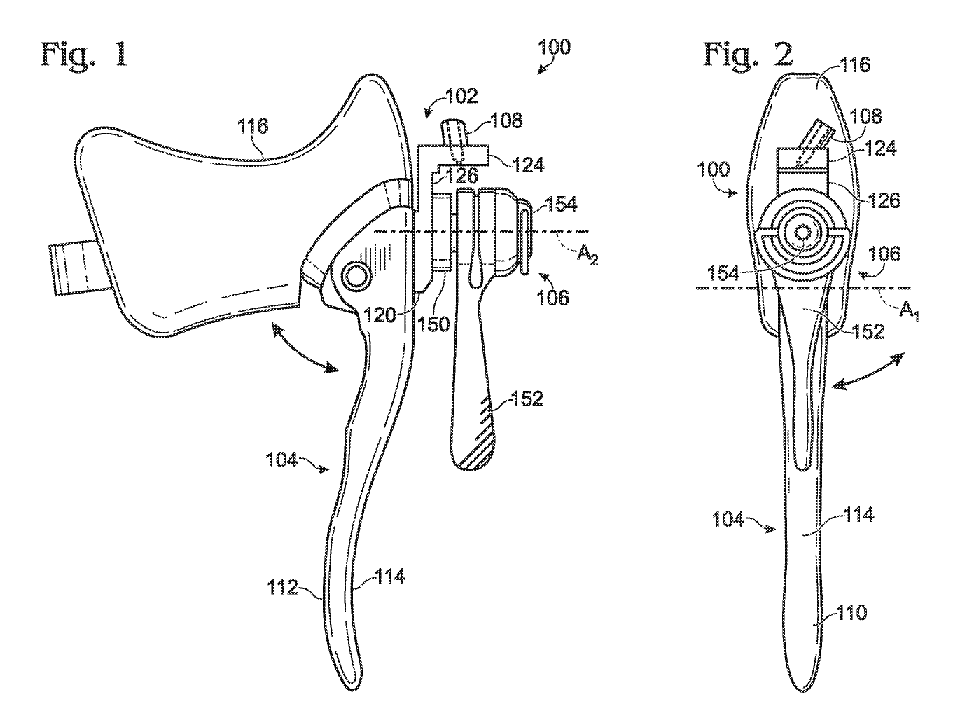

The present teachings disclose a control device, also referred to as a brake and shift lever assembly, for a bicycle handlebar, where the shift lever is configured to be attached to the front surface of the brake lever, i.e. the side of the brake lever farthest from the handlebar. The control device may include a shift lever mount that is integrally formed or otherwise manufactured in conjunction with the brake lever, or the control device can include a bracket or mount that attaches to a preexisting brake lever. Some embodiments of the disclosed control device may use specially made shift levers and/or brake levers, whereas other embodiments may allow the use of industry standard levers, including preexisting down tube and bar end style shift levers. Examples of control devices according to the present teachings are described in more detail below with reference to FIGS. 1-19.

FIG. 1 is a side elevational view and FIG. 2 is a front elevational view depicting a first example of a right-side control device, generally indicated at 100, according to aspects of the present teachings. Control device 100 also may be referred to as shift and brake lever assembly 100. Assembly 100 includes a lever support structure, which has a mounting assembly generally indicated at 102 attached to a rotatable brake lever generally indicated at 104 and a rotatable shift lever generally indicated at 106. Mounting assembly 102 may include one or more specially manufactured components that operatively attach securely to brake lever 104. Mounting assembly 102 also may provide an attachment point for shift lever 106 and/or a cable guide 108 adapted to receive and guide a derailleur cable (wire or hydraulic) passing between shift lever 106 and one of the bicycle derailleurs. Because FIG. 1 shows a right-side assembly, shift lever 106 would normally be associated with the rear derailleur of the bicycle. However, shift lever 106 may be associated with either derailleur.

Brake lever 104 may be adapted to be fixed to a bicycle handlebar, and defines a first axis of rotation A₁ that can be seen, for example, in FIG. 2. Rotation of brake lever 104 about axis of rotation A₁ is configured to move a control portion 110 of the brake lever generally toward and away from the handlebar to which the brake lever is mounted. Furthermore, brake lever 104 defines a first surface 112 configured to face generally toward the handlebar to which the brake lever is mounted, and a second surface 114 configured to face generally away from the handlebar. Control devices and assemblies according to the present teachings may be suitable for use on various styles of handlebars, such as drop-style handlebars, so-called “mustache bars,” and numerous other handlebar variants.

Rotatable shift lever 106 may be adapted to be fixed to brake lever 104 in a manner described below in more detail, and shift lever 106 defines a second axis of rotation A₂ that can be seen, for example, in FIG. 1. Shift lever axis A₂ may be substantially perpendicular to brake lever axis of rotation A₁ when the shift lever is attached to second surface 114 of the brake lever. Alternatively, axis A₂ may be oriented non-perpendicularly to axis A₁, such as at an angle of 70 degrees to 110 degrees. When control device 100 is fully installed on a bicycle, movement of the control portion of the brake lever generally toward and away from the handlebar is configured to apply an adjustable amount of tension to a brake cable, and rotation of the shift lever about the second axis of rotation is configured to apply an adjustable amount of tension to a shift cable. Because they are fixed together in the example of FIGS. 1-2, in this case operation of brake lever 104 also causes shift lever 106 as a whole to move through axis of rotation A₁ along with the brake lever. However, this movement alone does not affect tension on an associated shift cable.

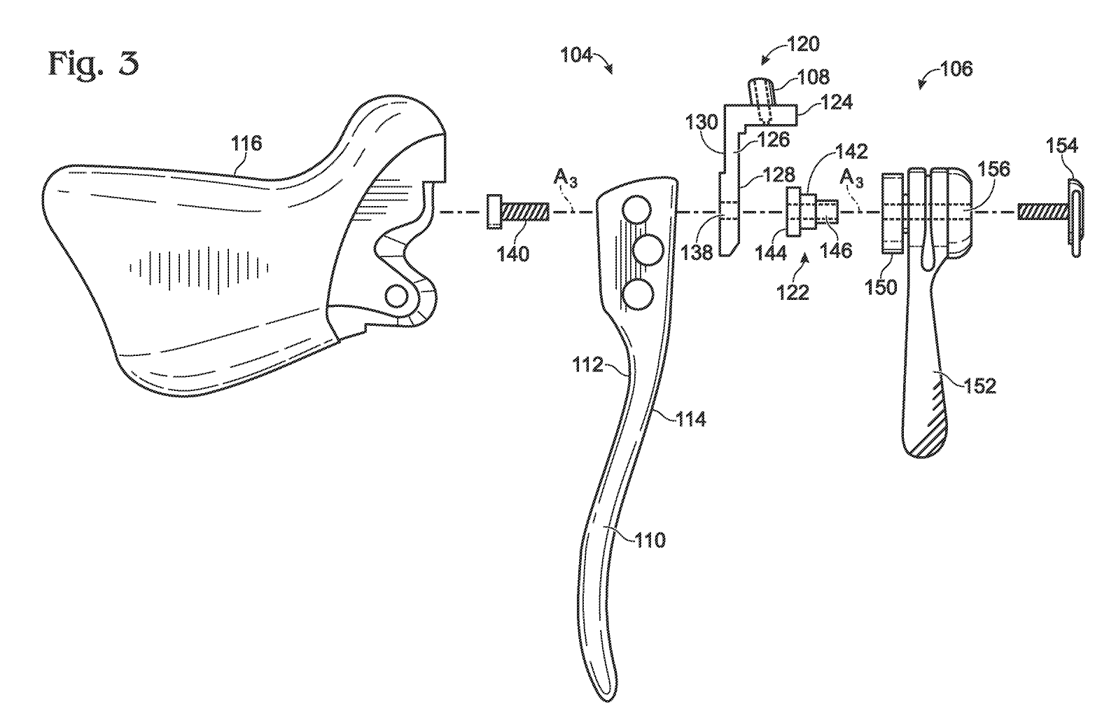

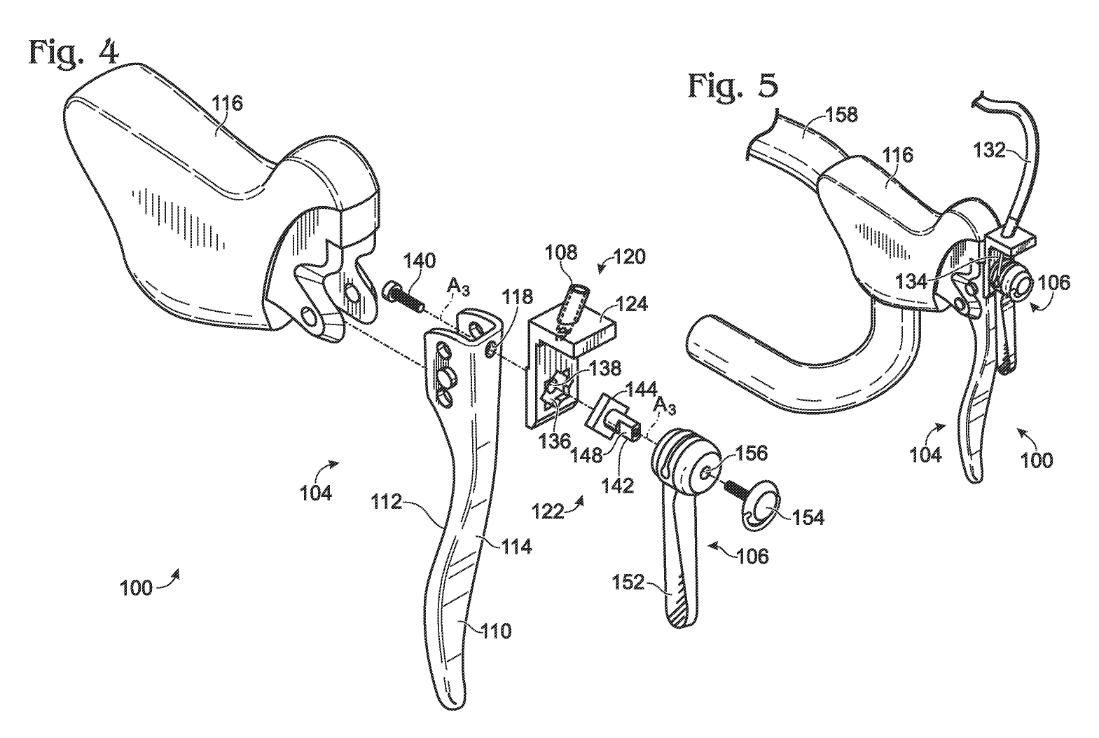

FIGS. 3 and 4 depict exploded views of illustrative control device 100, showing in more detail how the various components of the control device fit together. As depicted in FIGS. 3 and 4, brake lever 104 may be pivotably mounted to a brake lever hood assembly 116, which is typically securely attached to a handlebar. An aperture 118 passes through brake lever 104 near an upper end of the lever.

Mounting assembly 102 includes a mounting bracket, generally indicated at 120, and a shift lever boss or axle, generally indicated at 122, which together are configured to provide a suitable mounting surface and attachment point for mounting shift lever 106 to brake lever 104. Mounting bracket 120 includes a top flange 124 adapted to accommodate cable guide 108, and a body 126 extending generally perpendicular to top flange 124 and having a front surface 128 and a rear surface 130. Cable guide 108 includes a cylindrical extension protruding from a top surface of top flange 124. Cable guide 108 extends partially through a thickness of top flange 124, with a smaller hole passing completely through the flange, the smaller hole sized to stop a standard derailleur cable housing 132 while allowing a cable 134 to pass through unimpeded. In other examples, cable guide 108 may not include a cylindrical extension, but rather may simply include a hole bored into top flange 124 at a suitable angle and sized to receive a standard derailleur cable housing.

As depicted in FIG. 3, body 126 of mounting bracket 120 may be substantially planar and/or may have a stepped shape. In other examples, rear surface 130 of body 126 may include a concave portion to conform to or facilitate mating with a corresponding convex portion of second surface 114 of brake lever 104. Front surface 128 of body 126 may also be substantially planar. In some examples, front surface 128 may include a shaped recess 136 (see FIG. 4), which may include a discrete depression or recessed area of body 126. The interior surface of recess 136 may form a plane at a substantially continuous depth below the face of front surface 128. Recess 136 may be an indented, molded, or milled portion of front surface 128, and may be any suitable shape and depth configured to interface in a mating or interlocking manner with a surface of shift lever axle 122. For example, shaped recess 136 may include a recess having a rectilinear, star, or polygonal perimeter, and may allow selectable interlocking with shift lever axle 122 in a number of possible orientations. In some examples, shaped recess 136 may include a raised perimeter rising above the face of front surface 128.

Body 126 of mounting bracket 120 also includes an aperture 138 passing through body 126. Aperture 138 may be located at or near the center of shaped recess 136, when a shaped recess is provided. Mounting hardware such as a fastener 140 may pass through aperture 118 and aperture 138 before fastening to shift lever axle 122. In this sense, apertures 118 and 138 may be considered complementary apertures. In some embodiments, a second aperture (not shown) spaced from aperture 138 may be included in body 126 to allow attachment to a second corresponding aperture or protrusion on brake lever 104. Use of such a second aperture may facilitate stabilization of mounting bracket 120 relative to brake lever 104.

In some embodiments, mounting bracket 120 may include a plurality of discrete components rather than being formed as a single piece as depicted in FIGS. 3 and 4. For example, body 126 may be formed separately from top flange portion 124. In other embodiments, top flange 124 and/or cable guide 108 may not be present at all.

A shift lever axle according to the present teachings may be any suitable structure configured to provide a fastening point for fastener 140 as well as a mounting axle for shift lever 106. For example, shift lever axle 122 includes an axle portion 142 protruding from a base portion 144, with a central bore 146 running through both the axle and the base. Axle portion 142 is a generally cylindrical protrusion having a proximal end attached to or continuous with base portion 144. Axle portion 142 has flat sides 148 formed in a region proximate a distal end of the axle. In some other examples, two opposing flat sides may extend for the entire length of axle portion 142. Flat sides 148 may facilitate mounting of a shift lever, because some shift levers are keyed to such an axle shape in order to allow selectable alignment and positioning of lever action.

Central bore 146 in shift lever axle 122 includes an axial hole passing completely through a long axis of the shift lever axle. In some other examples, central bore 146 may be divided into two discrete central bore portions lying on a common axis. Central bore 146 may be threaded to facilitate engagement with one or more threaded fasteners. For example, fastener 140 may attach to one end of shift lever axle 122 by way of threaded engagement with central bore 146.

Base portion 144 of shift lever axle 122 takes the form of a substantially planar plate or rectilinear nut, and may be sized and shaped to interlock with recess 136. More specifically, base portion 144 has a square shape, sized to fit into star-shaped recess 136 in any one of several discrete positions. This arrangement locks shift lever axle 122 into a fixed position when fastener 140 is engaged, and facilitates selecting a desired orientation of flat sides 138 of axle portion 142.

As indicated in FIG. 3, for example, shift lever 106 includes a base 150, a handle 152, and a fastener 154. In the depicted embodiment, shift lever 106 is an industry standard down tube style shift lever. In other embodiments, the shift lever may be an industry standard bar end style shift lever, or a proprietary shift lever that is constructed specifically according to the present teachings, to integrate with the other portions of control device 100. In addition, the shift lever may be an indexed lever configured to rotate by discrete, predetermined amounts to apply discrete changes in tension to an associated shift cable, or the shift lever may be a non-indexed or friction-style lever. Furthermore, in some cases the shift lever may be adjustable during operation from an indexed state configured to rotate by discrete, predetermined amounts to a non-indexed state configured to rotate by continuous amounts selected by a user.

Shift lever 106 also includes an aperture 156, sized to allow fastener 154 to pass through and secure shift lever 106 to mounting assembly 102. For example, fastener 154 may be a threaded member and may secure shift lever 106 to the mounting assembly by engaging with a threaded central bore 146 of shift lever axle 122. In some embodiments, fastener 154 may be sized such that it may pass completely through shift lever axle 122 as well as complementary apertures 156, 138, and 118, engaging with additional mounting hardware adjacent first surface 112 of brake lever 104. For example, a threaded nut (not shown) may engage with a single fastener 154 to secure shift lever 106, mounting assembly 102, and brake lever 104.

From the previous discussion, it should be understood that aperture 118, aperture 138, central bore 146, and aperture 156 may all lie on a common longitudinal axis A₃, as depicted in FIGS. 3 and 4. This arrangement facilitates mounting and securing of the various components, and reduces the number of components required. For example, it allows a single component (the shift lever axle) to secure both the mounting bracket and the shift lever.

FIG. 5 is a perspective view showing illustrative shift and brake lever assembly 100 mounted to a bicycle handlebar 158. As depicted in FIG. 5, cable housing 132 may be held in a suitable position by cable guide 108. Derailleur cable 134 is shown passing through top flange 124 to engage with shift lever 106.

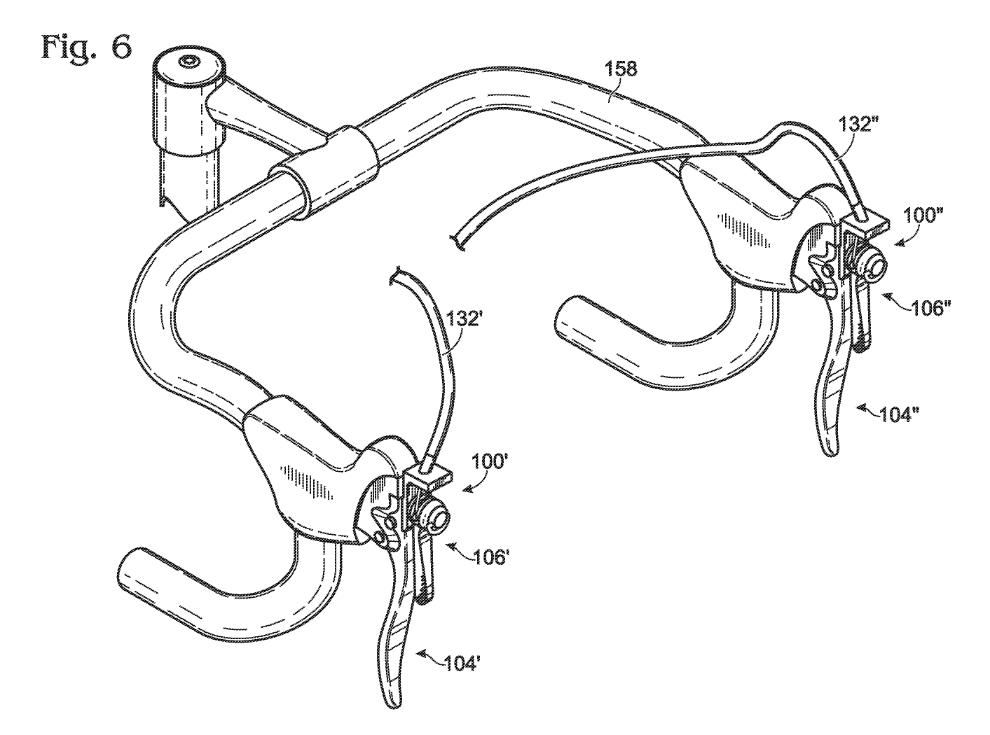

FIG. 6 is a perspective view of two assemblies, each of which is substantially similar to assembly 100 of FIGS. 1-5, mounted to a bicycle handlebar 158. A right side assembly 100′ may be in operational control of a rear derailleur, while a left side assembly 100″ may be in operational control of a front derailleur. Additional corresponding components of each assembly in FIG. 6 are indicated using similar single-prime (′) and double-prime (″) reference numerals. In some examples, the left and right side arrangement may be reversed. In other examples, only one assembly 100 may be mounted to a bicycle handlebar. For example, a rider may wish to install only a rear derailleur control assembly 100.

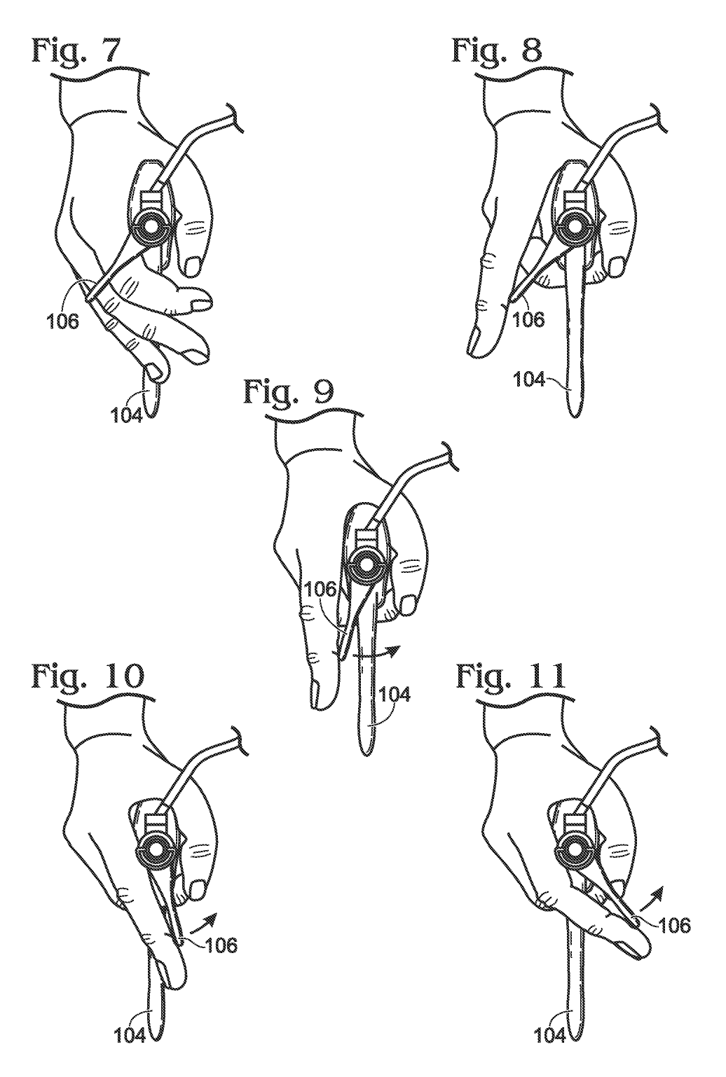

FIGS. 7-11 show the shift lever 106 of illustrative assembly 100 being rotated by hand through a range of operating positions. As depicted in FIGS. 7-11, assembly 100 facilitates such rotation while maintaining an operator's hand atop brake hood assembly 116. This mode of operation and/or shifting position may be desired in several situations. For example, it may be particularly advantageous in cyclo-cross racing, where a rider's hands are frequently positioned on the brake hoods.

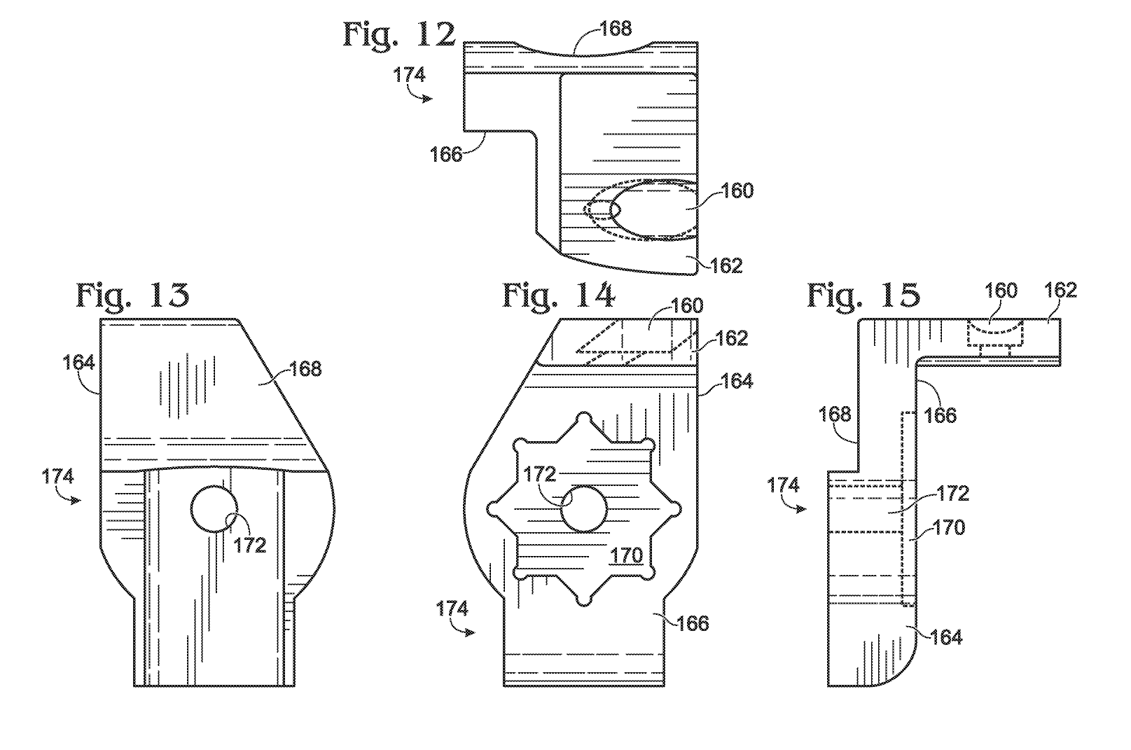

FIGS. 12-15 depict various magnified views of another illustrative mounting bracket, generally indicated at 174. FIG. 12 is a top view, FIG. 13 is a rear view, FIG. 14 is a front view, and FIG. 15 is a side view. As indicated in FIGS. 12-15, top flange 162 forms a horizontal planar portion of mounting bracket 120 configured to be located above shift lever 106 when installed. Top flange 162 includes cable guide 160, which in this case is configured as a bore hole passing at least partially through the flange. Cable guide 160 is angled to accommodate a derailleur cable that is attached to one side of shift lever 106.

With continuing reference to FIGS. 12-15, a substantially planar body portion 164 meets top flange 162 at an angle in order to position cable guide 160 above shift lever 106 to allow proper routing of cable 134. In the depicted embodiment, body 164 and top flange 162 form a right angle. In other embodiments, body 164 and top flange 162 may form an acute or obtuse angle. As can be seen, for example, in FIG. 14, front surface 166 includes a recessed portion 170 having a shape that facilitates mating or interlocking with base 144 of shift lever axle 122 in one of several possible orientations.

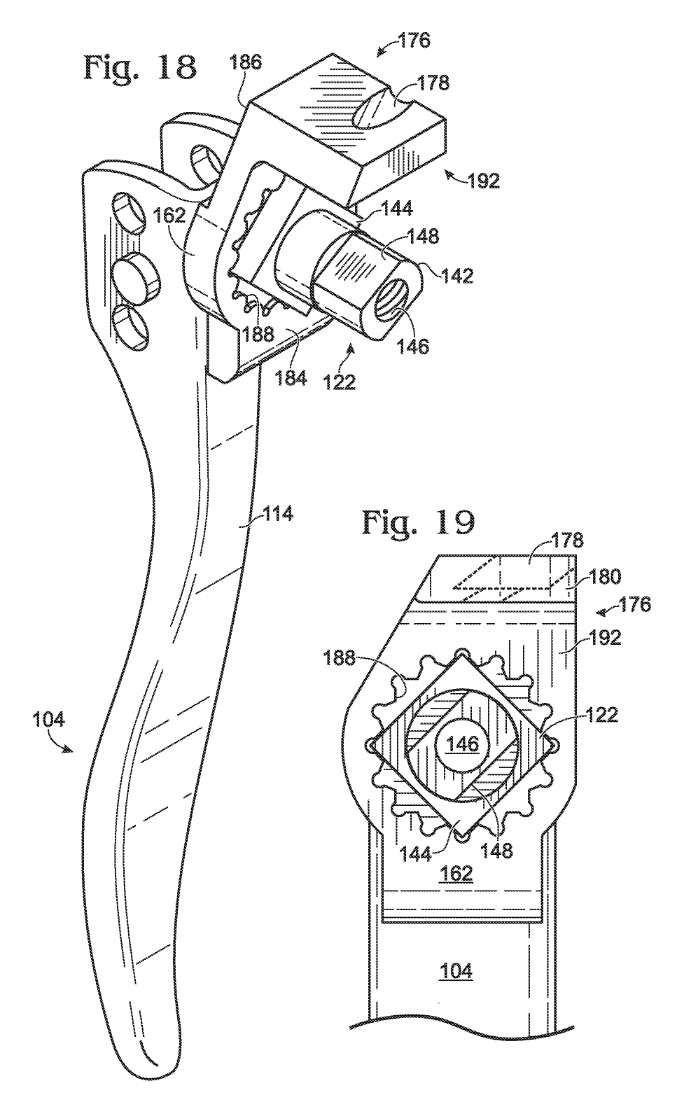

In the embodiment depicted in FIGS. 12-15, recess 170 is formed as an eight-pointed star shape (see FIG. 14) that facilitates orientation of a square base 144 in one of eight possible orientations. Shapes of recess 170 and/or base 144 may be varied to facilitate more or fewer interlocking orientations (see, e.g., FIGS. 18-19). A depth of recess 170 may be less than the thickness of base 144 of shift axle 122. As shown in the embodiment depicted in FIGS. 12-15, an aperture 172 passes completely through bracket 174 at or near the center of recess 170.

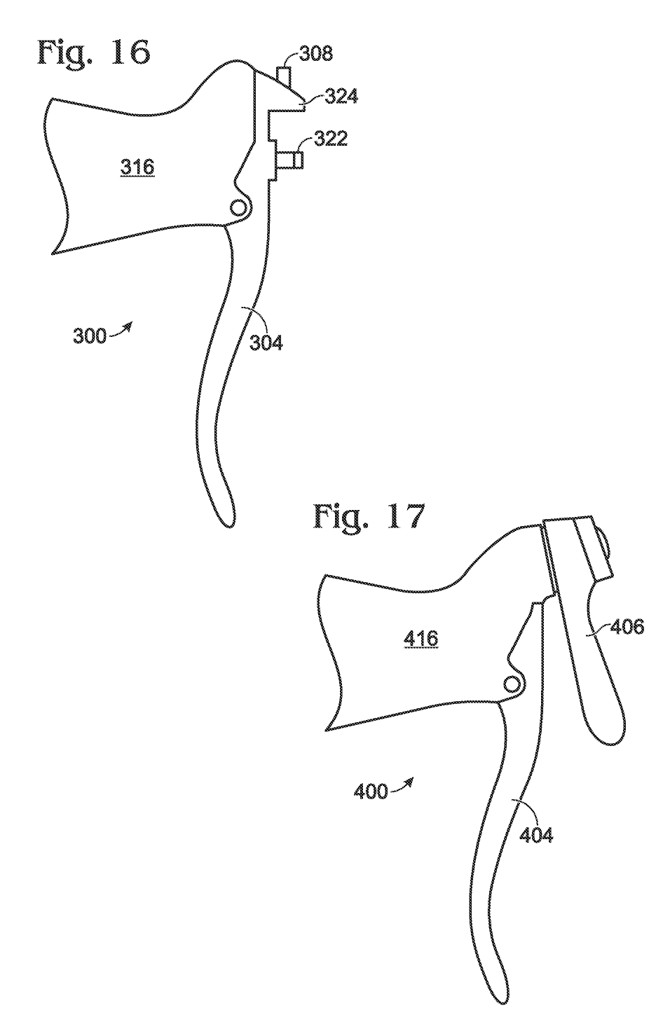

FIG. 16 is a side view of a portion of another exemplary assembly generally indicated at 300. Assembly 300 includes a brake lever 304 configured to include components similar to the components of mounting assembly 102 as an integrated part of the brake lever. For example, brake lever 304 includes a cable guide 308, a top flange 324, and a shift lever axle 322, all integrated into a single unit. Brake lever 304 is mounted on a brake hood assembly 316, and adapted to accept a shift lever such as shift lever 106 without the need for an intermediate mounting assembly.

FIG. 17 is a side view of yet another exemplary assembly generally indicated at 400. In this example, assembly 400 includes a standard brake lever 404 pivotably mounted to a brake hood assembly 416. Brake hood assembly 416 is adapted to accept shift lever assembly 406 by mounting the shift lever onto an upper portion of the brake hood assembly. This may be done, for example, by including an aperture in the upper portion of the brake hood assembly, to which the shift lever assembly may be mounted using suitable mounting hardware. As in previous embodiments, a shift lever axle such as shift lever axle 122 may be included or integrated into the upper portion of brake hood assembly 416 to facilitate mounting of shift lever assembly 406.

FIG. 18 is an isometric view and FIG. 19 is a front elevational view of yet another mounting assembly, generally indicated at 176, that may be used to attach a shift lever such as lever 106 to a brake lever such as lever 104. FIGS. 18-19 show a mounting bracket 192 attached to a brake lever 104 and a shift lever axle 122 installed in recess 188 of mounting bracket 192. Similar to previous mounting bracket embodiments, bracket 192 includes a cable guide 178 disposed in a top flange 180, a body portion 182 with a front surface 184, a rear surface 186, and an aperture 190. The body is connected to the top flange at a right angle. In this example, recess 188 is configured as a sixteen-pointed star. This configuration allows sixteen possible orientations of the square-based shift lever axle 122 depicted in the drawing.

The disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

1. A control device for mounting on a bicycle handlebar, the control device comprising:
a rotatable brake lever adapted to be attached to the handlebar and defining a first axis of rotation, wherein rotation of the brake lever about the first axis of rotation is configured to move a control portion of the brake lever generally toward and away from the handlebar, and wherein the control portion of the brake lever defines a first surface configured to face generally toward the handlebar and a second surface configured to face generally away from the handlebar; and
a rotatable shift lever adapted to be fixed to the brake lever and defining a second axis of rotation substantially perpendicular to the first axis of rotation, wherein the shift lever is operatively connected to the second surface of the brake lever.

2. The control device of claim 1, wherein the shift lever is fixed to the brake lever by mounting hardware passing through complementary apertures in the shift lever and the brake lever.

3. The control device of claim 1, further comprising a mounting assembly disposed between the brake lever and the shift lever, the mounting assembly including a mounting bracket and a shift lever axle.

4. The control device of claim 3, wherein the mounting assembly is fixed to the brake lever using a first fastener and the shift lever is fixed to the mounting assembly using a second fastener, and wherein the first and second fasteners share a common longitudinal axis.

5. The control device of claim 3, wherein a single fastener member fixes the mounting assembly to the brake lever and the shift lever to the mounting assembly.

6. The control device of claim 3, wherein the mounting bracket includes a cable guide adapted to receive and guide a derailleur cable passing between the shift lever and a derailleur.

7. The control device of claim 1, wherein the shift lever is a down tube style shift lever.

8. The control device of claim 1, wherein the shift lever is a bar end style shift lever.

9. The control device of claim 1, wherein movement of the control portion of the brake lever generally toward and away from the handlebar is configured to apply an adjustable amount of tension to a brake cable, and wherein rotation of the shift lever about the second axis of rotation is configured to apply an adjustable amount of tension to a shift cable.

10. The control device of claim 9, wherein the shift lever is an indexed lever configured to rotate by discrete, predetermined amounts to apply discrete changes in tension to the shift cable.

11. A control device for mounting on a bicycle handlebar, the control device comprising:
a rotatable brake lever adapted to be fixed to the handlebar and defining a first axis of rotation, wherein rotation of the brake lever about the first axis of rotation is configured to move a control portion of the brake lever generally toward and away from the handlebar; and
a rotatable shift lever adapted to be fixed to the brake lever and defining a second axis of rotation oriented at an angle between 70 degrees and 110 degrees relative to the first axis of rotation;
wherein the brake lever is disposed generally between the handlebar and the shift lever when the control device is mounted on the handlebar.

12. The control device of claim 11, wherein the shift lever is fixed to the brake lever by mounting hardware passing through complementary apertures in the shift lever and the brake lever.

13. The control device of claim 11, further comprising a mounting assembly disposed between the brake lever and the shift lever, the mounting assembly including a mounting bracket and a shift lever axle.

14. The control device of claim 13, wherein the mounting assembly is fixed to the brake lever using a first fastener and the shift lever is fixed to the mounting assembly using a second fastener, and wherein the first and second fasteners share a common longitudinal axis.

15. The control device of claim 13, wherein a single fastener member fixes both the mounting assembly to the brake lever and the shift lever to the mounting assembly.

16. The control device of claim 13, wherein the mounting bracket includes a cable guide adapted to receive and guide a derailleur cable passing between the shift lever and a derailleur.

17. The control device of claim 11, wherein the shift lever is a down tube style shift lever.

18. The control device of claim 11, wherein the shift lever is a bar end style shift lever.

19. The control device of claim 11, wherein movement of the control portion of the brake lever generally toward and away from the handlebar is configured to apply an adjustable amount of tension to a brake cable, and wherein rotation of the shift lever about the second axis of rotation is configured to apply an adjustable amount of tension to a shift cable.

20. The control device of claim 19, wherein the shift lever is an indexed lever configured to rotate by discrete, predetermined amounts to apply discrete changes in tension to the shift cable.

21. A control device for mounting on a bicycle handlebar, the control device comprising:
a lever support structure configured to attach securely to the handlebar;
a first pivot axis disposed at an upper region of the lever support structure;
a brake lever pivotably connected to the lever support structure through the first pivot axis, wherein a control portion of the brake lever defines an inner brake lever surface configured to face generally toward the handlebar and an outer brake lever surface configured to face generally away from the handlebar;
a second pivot axis disposed at the upper region of the lever support structure in proximity to the first pivot axis;
a shift lever pivotably connected to the lever support structure through the second pivot axis and having a plurality of gear change control positions, wherein a control portion of the shift lever defines an inner shift lever surface configured to face generally toward the handlebar and an outer shift lever surface configured to face generally away from the handlebar;
wherein the outer brake lever surface is overlapped by the inner shift lever surface.

22. The control device of claim 21, wherein the shift lever is fixed to the brake lever by mounting hardware passing through complementary apertures in the shift lever and the brake lever.

23. The control device of claim 21, further comprising a mounting assembly disposed between the brake lever and the shift lever, the mounting assembly including a mounting bracket and a shift lever axle.

24. The control device of claim 23, wherein the mounting assembly is fixed to the brake lever using a first fastener and the shift lever is fixed to the mounting assembly using a second fastener, and the first and second fasteners share a common longitudinal axis.

25. The control device of claim 23, wherein a single fastener member fixes both the mounting assembly to the brake lever and the shift lever to the mounting assembly.

26. The control device of claim 21, wherein the shift lever is configured to be adjusted during operation from an indexed state configured to rotate by discrete, predetermined amounts to a non-indexed state configured to rotate by continuous amounts selected by a user.

27. A control device for mounting on a bicycle handlebar, the control device comprising:
a rotatable brake lever adapted to be fixed to the handlebar and defining a first axis of rotation, wherein rotation of the brake lever about the first axis of rotation is configured to move a control portion of the brake lever generally toward and away from the handlebar; and
a mounting assembly defining a second axis of rotation substantially perpendicular to the first axis of rotation and adapted to attach to the brake lever using a fastener passing through complementary apertures in the mounting assembly and the brake lever;
wherein the mounting assembly is configured to receive a shifter component that is rotatable about the second axis of rotation and that is disposed generally farther from the handlebar than the brake lever, with the brake lever disposed generally between the shifter component and the handlebar.

28. The control device of claim 27, wherein the mounting assembly includes a mounting bracket and a shift lever axle.

29. The control device of claim 28, wherein the mounting assembly further includes a derailleur cable guide.

30. The control device of claim 28, wherein a first portion of the shift lever axle is configured to interlock with a recess in the mounting bracket, and a second portion of the shift lever axle is configured to receive the shifter component
